(19) United States
(12) Patent Application Publication
(10) Pub. No.: US 2026/0128398 A1
(43) Pub. Date: May 7, 2026

(54) CALIBRATING MEDICAL SYSTEM BACKUP BATTERIES

(71) Applicant: GE Precision Healthcare LLC, Waukesha, WI (US)

(72) Inventors: Chetankumar A. Modi, Bangalore (IN); Chekkizhar Pandiyan, Bangalore (IN); Hariprasad Kodancha, Bangalore (IN); Ashutosh Kumar, Bangalore (IN)

(73) Assignee: GE Precision Healthcare LLC, Waukesha, WI (US)

(21) Appl. No.: 18/939,855

(22) Filed: Nov. 7, 2024

(51) Int. Cl. H01M 10/48; H01M 10/42

(52) U.S. Cl. CPC H01M 10/482; H01M 10/425; H01M 2010/4271

(57) ABSTRACT

A system for calibrating medical system backup batteries includes a processing device and a memory storage device. The memory storage device includes instructions executable by the processor to receive a shutdown request to shut down a medical system having a backup battery. Additionally, the instructions are executable by the processor to determine, in response to receiving the shutdown request, that the backup battery is due for calibration based on a current date and a calibration due date. Further, the instructions are executable by the processor to provide a request for a fuel gauge board of a power management board for the medical system to perform a discharge of the backup battery.

### BACKGROUND

The present disclosure generally relates to calibration, and specifically to calibrating medical system backup batteries.

Medical systems, such as anesthesia and respiratory medical systems, are class-C devices, which use a backup battery. The backup battery is useful for keeping the medical system functions working when there is main alternating current (AC) power loss.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one aspect of the disclosure, a system for calibrating medical system backup batteries includes a processing device and a memory storage device. The memory storage device includes instructions executable by the processor to receive a shutdown request to shut down a medical system having a backup battery. Additionally, the instructions are executable by the processor to determine, in response to receiving the shutdown request, that the backup battery is due for calibration based on a current date and a calibration due date. Further, the instructions are executable by the processing device to provide a request for a fuel gauge board of a power management board for the medical system to perform a discharge of the backup battery.

In one embodiment, the system includes the power management board for the medical system and the fuel gauge board. Further, the fuel gauge board includes at least two power resistors configured to discharge power from the backup battery.

In another embodiment, the fuel gauge board is configured to direct the at least two power resistors to discharge the power from the backup battery, such that a state of charge of the backup battery is reduced to at least a predetermined threshold.

In another embodiment, the fuel gauge board is configured to direct at least one remaining functional power resistor of the at least two power resistors to discharge the power from the backup battery when a different power resistor of the at least two power resistors fails.

In another embodiment, the instructions are executable by the processing device to direct the power management board to charge the backup battery for a predetermined period.

In another embodiment, the instructions are executable by the processing device to direct the power management board to shut down the medical system.

In another embodiment, the instructions are executable by the processing device to direct the power management board to end the predetermined period. Additionally, the instructions are executable by the processing device to direct the power management board to start the medical system

In another embodiment, the instructions are executable by the processing device to provide a shutdown confirmation interface. Additionally, the instructions are executable by the processing device to receive a shutdown confirmation from the shutdown confirmation interface. Further, determining that the calibration is due is performed in response to receiving the shutdown confirmation from the shutdown confirmation interface.

In another embodiment, the instructions are executable by the processing device to provide a calibration confirmation interface. Additionally, the instructions are executable by the processing device to receive a calibration confirmation selection. Further, the request for the fuel gauge board of the power management board for the medical system to perform the discharge of the backup battery is provided in response to receiving a selection of the calibration confirmation.

In another embodiment, the instructions are executable by the processing device to provide a charging interface. Additionally, the instructions are executable by the processing device to receive a start case selection from the charging interface. Further, the instructions are executable by the processing device to direct the power management board to start the medical system in response to receiving the start case selection.

In another embodiment, the instructions are executable by the processing device to receive an indication that the discharge is complete. Additionally, the instructions are executable by the processing device to update the calibration due date based on the current date and a predetermined battery calibration period.

In another aspect of the disclosure, a method for calibrating medical system backup batteries includes receiving a shutdown request to shut down a medical system having a backup battery. Additionally, the method includes determining, in response to receiving the shutdown request, that the backup battery is due for calibration based on a current date and a calibration due date. Further, the method includes providing a request for a fuel gauge board of a power management board for the medical system to perform a discharge of the backup battery.

In an embodiment, the method includes directing a fuel gauge board of a power management board for the medical system to discharge power from the backup battery, such that a state of charge of the backup battery is reduced to at least a predetermined threshold.

In another embodiment, the method includes directing a first power resistor of at least two power resistors of the fuel gauge board to discharge the power from the backup battery when a second power resistor of the at least two power resistors fails.

In another embodiment, the method includes directing the power management board to charge the backup battery for a predetermined period.

In another embodiment, the method includes directing the power management board to shut down the medical system.

In another embodiment, the method includes directing the power management board to end the predetermined period. Additionally, the method includes directing the power management board to start the medical system.

In another embodiment, the method includes providing a shutdown confirmation interface. Further, the method includes receiving a shutdown confirmation from the shutdown confirmation interface. Additionally, determining that the calibration is due is performed in response to receiving the shutdown confirmation from the shutdown confirmation interface.

In another embodiment, the method includes providing a calibration confirmation interface. Further, the method includes receiving a calibration confirmation selection, wherein the request for the fuel gauge board of the power management board for the medical system to perform the discharge of the backup battery is provided in response to receiving a selection of the calibration confirmation.

In another embodiment, the method includes receiving an indication that the discharge is complete from the power management board. Additionally, the method includes updating the calibration due date based on the current date and a predetermined battery calibration period.

Various other features, objects, and advantages of the invention will be made apparent from the following description taken together with the drawings.

### BRIEF DESCRIPTION OF THE DRAWINGS

The present disclosure is described with reference to the following Figures.

FIG. 1 is a diagram of a system for calibrating medical system backup batteries according to one embodiment of the present disclosure.

FIG. 2 is a message flow diagram of a system for calibrating medical system backup batteries according to one embodiment of the present disclosure.

FIG. 3 is a diagram of a calibration confirmation user interface of a system for calibrating medical system backup batteries according to one embodiment of the present disclosure.

FIG. 4 is a diagram of a calibration user interface of a system for calibrating medical system backup batteries according to one embodiment of the present disclosure.

FIG. 5 is a diagram of a charging user interface of a system for calibrating medical system backup batteries according to one embodiment of the present disclosure.

FIG. 6 is a flow chart of a method for a system for calibrating medical system backup batteries according to one embodiment of the present disclosure.

FIG. 7 is a flow chart of a method for a system for calibrating medical system backup batteries according to one embodiment of the present disclosure.

FIG. 8 is a flow chart of a method for a system for calibrating medical system backup batteries according to one embodiment of the present disclosure.

FIG. 9 is a diagram of fuel gauge board according to one embodiment of the present disclosure.

FIG. 10 is a diagram of a system for calibrating medical system backup batteries according to one embodiment of the present disclosure.

FIG. 11 is an exemplary calibrating medical system backup batteries manager according to one embodiment of the present disclosure.

### DETAILED DESCRIPTION

In the present description, certain terms have been used for brevity, clarity and understanding. No unnecessary limitations are to be inferred therefrom beyond the requirement of the prior art because such terms are used for descriptive purposes only and are intended to be broadly construed.

As used herein, unless otherwise limited or defined, discussion of particular directions is provided by example only, with regard to particular embodiments or relevant illustrations. For example, discussion of “top,” “bottom,” “front,” “rear,” “left,” “right,” “horizontal,” “vertical,” and “longitudinal” features and/or relative motion, e.g., movement “up” and “down,” is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally or alternatively, embodiments may be arranged in a different orientation such that “top” and “bottom” features are arranged horizontally relative to each other, for example in a “left-to-right” orientation.

The use herein of the terms “including,” “comprising,” or “having,” and variations thereof, is meant to encompass the elements listed thereafter and equivalents thereof, as well as additional elements. Embodiments recited as “including,” “comprising,” or “having” certain elements are also contemplated as “consisting essentially of” and “consisting of” those certain elements.

As stated previously, a backup battery is useful for keeping medical system functions working when there is main alternating current (AC) power loss. However, with medical devices being used during surgery in hospitals, the main AC power loss rate may be limited. As such, the backup battery may not be used frequently. This infrequent use of the backup battery may mean that the battery is charging while fully charged, which causes a degradation of the battery health. A degraded battery can be a danger to patient health, and thus, may be serviced and/or replaced, which involves the expenses of employing a field service technician and potentially purchasing a replacement battery.

Further, during main AC power loss, accurate battery health monitoring, and accurate battery health indicators are useful for clinicians to plan their activities with the medical system. For example, if a battery health monitor indicates that a backup battery can provide one hour of power for a medical system, and the clinician plans to use the medical system for at least two hours, the clinician can arrange to make an additional backup power source available for at least the second hour of use. However, indicators of battery health on a degraded backup battery may not be accurate. Hence, inaccurate information about the amount of backup power available means the clinician may be unaware that there is insufficient power for the clinician’s planned use of the medical system. As such, a clinician may fail to plan for additional backup power in a timely manner, which could be fatal to a patient when the clinician is planning on the medical system to be powered for the indicated amount of time.

Accordingly, some embodiments of the present disclosure may provide a non-disruptive, automatic battery calibration that does not interfere with the normal operation of the medical systems using backup batteries. Such embodiments may discharge the battery to a predetermined state of charge using an electrical arrangement and software to maintain battery health. Such embodiments may help convey an accurate indication of battery health for the use of medical systems with backup battery power. Additionally, such embodiments may perform the calibration automatically during medical system shutdown. As such, this calibration can be performed without the cost or inconvenience of staff or customer labor. Further, such embodiments may not cause downtime for the medical system being powered by the backup battery. Additionally, by periodically and automatically calibrating the battery, such embodiments may reduce field engineer visits to maintain and/or replace backup batteries. As such, embodiments of the present disclosure may reduce the financial cost of maintaining backup batteries. Further, such embodiments may reduce the amount of time spent calibrating backup batteries. For example, some embodiments may reduce the calibration time from approximately five hours to approximately three hours.

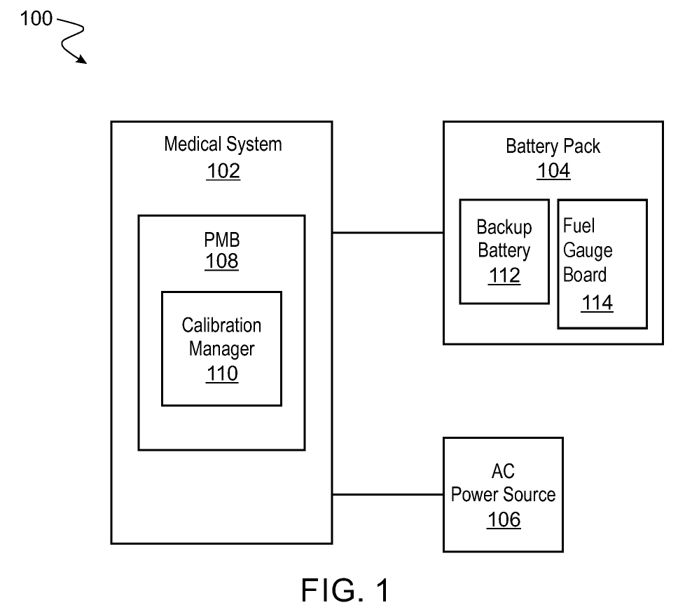

FIG. 1 is a diagram of a system 100 for calibrating medical system backup batteries according to one embodiment of the present disclosure. The system 100 includes medical system 102, battery pack 104, and alternating current (AC) power source 106. Further, the battery pack 104 includes a backup battery 112 and a calibration circuit 114. The AC power source 106 may be a source of electrical current provided from a power plant, or other power generation facility.

The medical system 102 may represent a medical device, such as an anesthesia and respiratory medical system. As stated previously, the medical system 102 may use the backup battery 112 to keep the medical system 102 functions working when there is a power loss of the AC power source 106.

Additionally, the medical system 102 includes a power management board (PMB) 108. The PMB 108 may be a device that regulates power use by the medical system 102. For example, based on operating conditions, the PMB 108 may direct power from power sources, such as the AC power source 106 and the backup battery 112, to the medical system 102. More specifically, the PMB 108 may monitor the availability of the AC power source 106, and direct power from the AC power source 106 to the medical system 102 when the AC power source 106 is available. Conversely, when the PMB 108 determines there is power loss of the AC power source 106, the PMB 108 may direct power from the backup battery 112 to the medical system 102. Further, the PMB 108 may include a calibration manager 110.

The calibration manager 110 may be a processing system, such as a computer processing system, system on a chip, and the like, configured to interface with the medical system 102, and PMB 108. More specifically, the calibration manager 110 may be configured to provide user interfaces that enable an operator to calibrate the backup battery 112. Calibrating the backup battery 112 may involve directing the PMB 108 to periodically discharge the backup battery 112 according to a predetermined schedule. In this way, the calibration manager 110 may mitigate battery degradation, and thus maintain battery health. Additionally, calibrating the backup battery 112 in this way may improve the accuracy of the fuel gauge’s estimate of backup battery health, and thus the PMB’s time estimate of backup battery power during an AC power source loss.

The battery pack 104 may include a backup battery 112 and fuel gauge board 114. The fuel gauge board 114 may include a fuel gauge (not shown) that can determine the state of charge of the backup battery 112. As such, when the AC power source 106 is lost, the PMB 108 may use the fuel gauge of the fuel gauge board 114 to determine the backup battery’s state of charge. Further, the PMB 108 may estimate an amount of time that the backup battery 112 may last based on the state of charge. Accordingly, the PMB 108 may provide this time estimate for battery backup power on a display or other presentation device. Alternatively, the PMB 108 may provide this time estimate for the calibration manager 110, which may provide the time estimate for backup battery power on a display or other presentation device. Additionally, the fuel gauge board 114 may be configured to provide power from the backup battery 112 to the medical system 102.

Further, according to some embodiments of the present disclosure, the fuel gauge board 114 may be configured to calibrate the backup battery 112. More specifically, the fuel gauge board 114 may be configured to discharge power from the backup battery 112 to a predetermined threshold, e.g., a specific state of charge, in response to a request from the calibration manager 110.

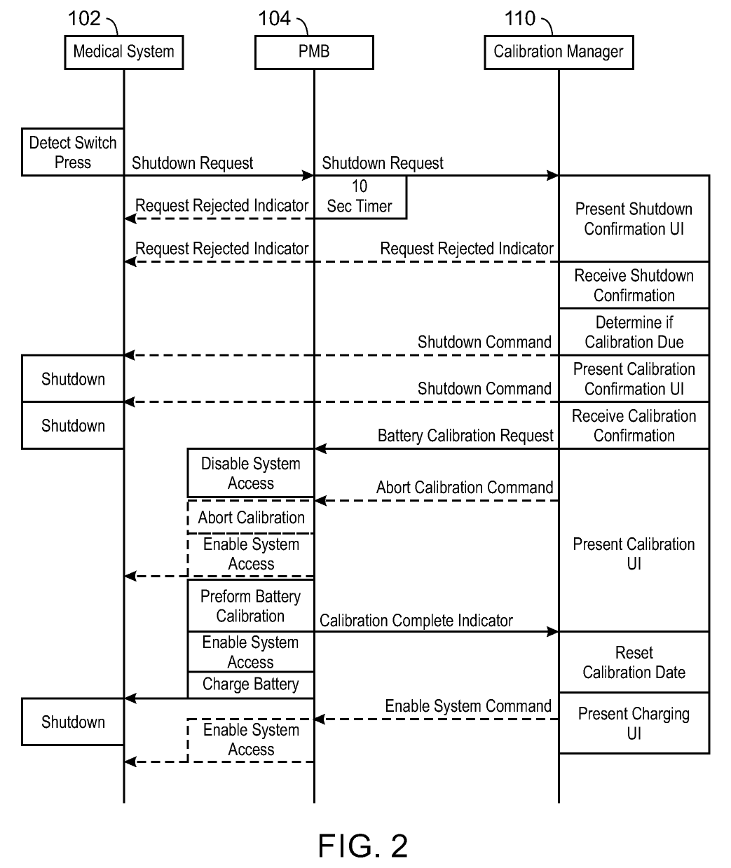

FIG. 2 is a message flow diagram 200 of the system 100 for calibrating medical system backup batteries according to one embodiment of the present disclosure. The message flow diagram 200 includes actors (indicated at the top of each vertical line), actions (indicated in boxes along the vertical lines), and messages (indicated by horizontal lines between the actors). The text above each message line may indicate data, and/or commands that the sending actor may include in the message. Further, the actions and messages are represented in solid and dashed lines. With respect to the solid lines, these represent actions or messages that the actors take or send, respectively. However, with respect to the dashed lines, these represent actions and messages that the actors may optionally take and send, respectively, as described below.

More specifically, the actors of the message flow diagram 200 include the medical system 102, PMB 108, and calibration manager 110, described with respect to FIG. 1. As shown, the medical system 102 may detect a standby (e.g., power) switch press on the medical system 102. The power switch press may indicate a power off operation request from an operator of the medical system 102. Accordingly, medical system 102 may send a shutdown request to the PMB 108. Upon receipt of the shutdown request, the PMB 108 may begin a countdown timer, e.g., a 10-second timer. If the countdown timer expires without receiving a confirmation, the PMB 108 may send a request rejected indicator to the medical system 102, which may resume operation. The PMB 108 may also send the shutdown request to the calibration manager 110. In response, the calibration manager 110 may present a shutdown confirmation user interface (UI). The calibration manager 110 may present the shutdown confirmation user interface as a prompt on a display device (not shown), to which an operator may respond to confirm, or reject, the shutdown request. Additionally, the shutdown confirmation user interface may include a display representing the ticking down of the countdown timer. If the confirmation is rejected, the calibration manager 110 may send a request rejected indicator to the PMB 108. Additionally, the PMB 108 may send the request rejected indicator to the medical system 102.

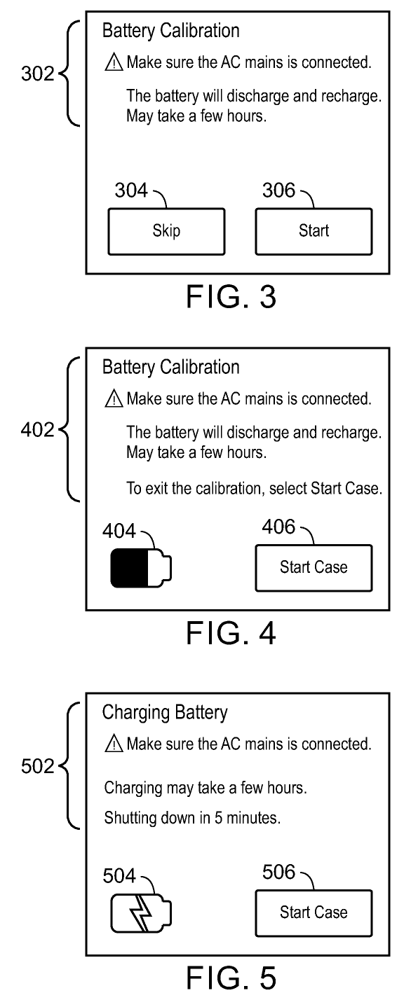

Alternatively, the calibration manager 110 may receive a shutdown confirmation. In other words, the operator may make a selection via the display device to confirm the shutdown request. In response to the confirmation, the calibration manager 110 may determine whether the backup battery 112 is due for calibration. According to some embodiments of the present disclosure, the calibration manager 110 may maintain a local data store (not shown) that provides the next due date for calibration. The due dates may be scheduled on a periodic basis, e.g., once per quarter (i.e., every three months), once per year, and the like. Accordingly, the calibration manager 110 may compare the current date to the calibration due date. If the calibration is not due, the calibration manager 110 may send a shutdown command to the medical system 102, which may perform a shutdown in response. However, if the calibration is due, the calibration manager 110 may present a calibration confirmation user interface. In other words, the calibration manager 110 may present a prompt on the display device, to which the operator may respond, indicating a confirmation, or rejection, of the calibration. Similar to the shutdown confirmation user interface, the calibration manager 110 may also present a countdown timer, during which the operator can confirm the calibration. If the countdown timer expires, or the operator rejects the calibration confirmation, the calibration manager 110 may send a shutdown command to the medical system 102, which may shut down in response. The calibration confirmation user interface is described in greater detail with respect to FIG. 3.

Alternatively, if the operator confirms the calibration, i.e., the calibration manager 110 receives the calibration confirmation, the calibration manager 110 may present a calibration user interface. The calibration user interface may present a dynamic representation of the progress of the calibration. Further, the calibration user interface may provide an operator-selectable option to resume operation of the medical system 102, thus aborting the calibration. Accordingly, if the operator selects the option to resume operation of the medical system 102 (referred to herein as a start case), the calibration manager 110 may send an abort calibration command to the PMB 108. In response, the PMB 108 may abort calibration. Additionally, the PMB 108 may enable system access, i.e., access to the medical system 102. Further, the fuel gauge board 114 may enable charging of the backup battery. The calibration user interface is described in greater detail with respect to FIG. 4.

In addition to providing the calibration user interface, the calibration manager 110 may send a battery calibration request to the PMB 108. In response, the PMB 108 may disable system access, i.e., disable access to operation of the medical system 102. Further, the PMB 108 may disable the AC power source 106 from charging the backup battery 112, as it is not possible to calibrate the backup battery 112 while charging. Accordingly, once the PMB 108 disables battery backup charging, the PMB 108 may perform calibration of the backup battery 112. Performing calibration may involve discharging the backup battery 112 using one or more resistors of the calibration circuit 114. According to some embodiments of the present disclosure, the PMB 108 may discharge the backup battery 112 to a predetermined threshold, i.e., a lower level state of charge. The predetermined threshold may be based on the state of charge that enables an improved health of the backup battery when recharging. When the backup battery 112 reaches the predetermined state of charge, the calibration is complete.

When the calibration is complete, the fuel gauge board 114 may begin charging the backup battery 112. Charging the backup battery 112 may involve enabling the AC power source 106 to charge the backup battery 112. According to some embodiments of the present disclosure, the fuel gauge board 114 may perform this charging for a predetermined period of time, e.g., five minutes. When the charging period is complete, the PMB 108 may send a shutdown command to the medical system 102, in response to which, the medical system 102 may shut down.

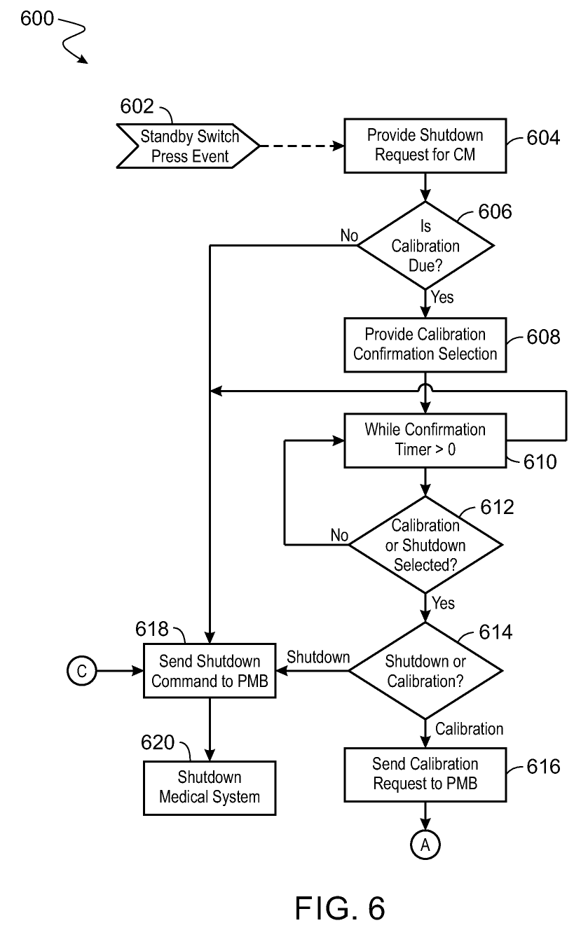

In addition to charging the backup battery 112 when calibration is complete, the PMB 108 may send a calibration complete indicator to the calibration manager 110. In response, the calibration manager 110 may update the calibration due date. Updating the calibration due date may involve determining the next due date for battery calibration. Accordingly, for quarterly calibrations, the calibration manager 110 may determine the calibration due date by adding three months to the current date. Additionally, the calibration manager 110 may present a charging user interface, described with respect to FIG. 5. The charging UI may display a progress of the charging, and a countdown timer for the predetermined charging period. Additionally, the charging UI may provide an operator-selectable option to end the predetermined charging period, and start the medical system 102, i.e., the start case. If the operator selects the option for the start case, the calibration manager 110 may send an enable system command to the PMB 108. In response, the PMB 108 may enable access to the medical system 102.

Alternatively, if the operator does not select the start case, when the predetermined charging period ends, the calibration manager 110 may send a shutdown command to the medical system 102. In response, the medical system 102 may shutdown. Further, while shutdown, the PMB 108 may continue charging the backup battery 112.

FIG. 3 is a diagram of a calibration confirmation user interface 300 of a system for calibrating medical system backup batteries according to one embodiment of the present disclosure. More specifically, the calibration manager 110 may present the calibration confirmation user interface 300 on a display or other output device in response to receiving a shutdown request from the PMB 108. The calibration confirmation user interface 300 includes a message 302, skip selection 304, and start selection 306. The message 302 provides instructions for the operator to follow in the event the operator elects to confirm the battery calibration.

For example, the skip selection 304 may be a button or other user interface element that the operator may select, click on, or otherwise engage, to reject the battery calibration confirmation. Thus, if the operator clicks on the skip selection 304, the calibration manager 110 may send a shutdown command to the PMB 108, which may send the shutdown command to the medical system 102, which may shutdown.

Further, the start selection 306 may be a button or other user interface element that the operator may select, click on, or otherwise engage, to accept the battery calibration confirmation. Thus, if the operator clicks on the start selection 306, the calibration manager 110 may send a battery calibration request to the PMB 108, which may perform calibration on the backup battery 112, as described with respect to FIG. 2.

FIG. 4 is a diagram of a calibration user interface 400 of a system for calibrating medical system backup batteries according to one embodiment of the present disclosure. More specifically, the calibration manager 110 may display the calibration user interface 400 at the beginning of the battery calibration operation. Thus, in addition to sending the battery calibration request to the PMB 108, the calibration manager 110 may also present the user interface 400 on a display or other output device. The calibration user interface 400 may provide the operator with an option to stop the battery calibration, and resume the operation of the medical system 102. This functionality may be useful in order to resume use of the medical system 102, which may not be available during battery calibration. More specifically, the user interface 400 includes a message 402, battery discharge indicator 404 and start case selection 406. The message 402 is similar to the message 302. However, in addition, the message 402 includes the instruction, “To exit the calibration, select Start Case.” The battery discharge indicator 404 can graphically represent the state of charge of the backup battery 112. However, in some embodiments of the present disclosure, the battery charge indicator 404 may include a number indicating a voltage charge, or a percentage of full charge. The start case selection 406 may be a button or other user interface element that the operator may select, click on, or otherwise engage, to stop the calibration and resuming operation of the medical system 102. Thus, if the operator clicks on the start case selection 406, the calibration manager 110 may send an abort calibration command to the PMB 108, as described with respect to FIG. 2.

FIG. 5 is a diagram of a charging user interface 500 of a system for calibrating medical system backup batteries according to one embodiment of the present disclosure. More specifically, the calibration manager 110 may display the charging user interface 500 in response to receiving the calibration complete indicator from the PMB 108, as described with respect to FIG. 2. As stated previously, the PMB 108 sends the calibration complete indicator after battery calibration is complete, and at the beginning of the battery charging operation. Further, at completion of battery charging for the duration of the predetermined charging period, the PMB 108 may send a shutdown command to the medical system 102. As such, the calibration manager 110 may present the charging user interface 500 on a display, or other output device, to provide the operator with an option to prevent shutdown, and resume operation of the medical system 102. More specifically, the charging user interface 500 includes a message 502, battery charge indicator 504, and start case selection 506. The message 502 provides information and instruction for the operator. Additionally, the message 502 includes a time indication, e.g., a countdown timer, for when the medical system 102 shuts down. The start case selection 506 may be a button or other user interface element that the operator may select, click on, or otherwise engage, to prevent shutdown and resume operation of the medical system 102. Thus, in response to the operator clicking on the start case selection 506, the calibration manager 110 may send the enable system command to the PMB 108, as described with respect to FIG. 2.

FIG. 6 is a flow chart of a method 600 for a system for calibrating medical system backup batteries according to one embodiment of the present disclosure. The medical system 102, PBM 108, and calibration manager 110 may perform the method 600.

At operation 602, a standby switch press event may occur on the medical system 102. The standby switch may also be referred to as a power switch. When the standby switch press event occurs when the medical system 102 is powered on, the event may represent an operator request to shutdown the medical system 102.

At operation 604, the PMB 108 may provide a shutdown request for the calibration manager (CM) 110. As stated previously, the medical system 102 may provide the shutdown request to the PMB 108 in response to receiving a shutdown request from the medical system 102. Additionally, the PMB 108 may provide the shutdown request to the calibration manager 110.

At operation 606, the calibration manager 110 may determine if a calibration is due. As stated previously, determining whether a calibration is due may involve comparing the current date to a locally stored calibration due date. The calibration manager 110 may maintain the calibration due date based on a predetermined schedule, such as a quarterly, semi-annual, or annual schedule, and the like. If the calibration is not due, control of the method 600 may flow to operation 618. However, if the calibration is due, control of the method 600 may flow to operation 608.

At operation 608, the calibration manager may provide a calibration confirmation user interface. Providing the calibration confirmation user interface may involve presenting a user interface, such as the calibration confirmation user interface 300, described with respect to FIG. 3.

With respect to operations 610 through 612, the calibration manager 110 may perform operations 610 through 612 while the confirmation timer is greater than zero. As stated previously, the calibration confirmation user interface 300 may be associated with a countdown timer, i.e., the confirmation timer. According to operation 610, when the confirmation timer expires, i.e., is no longer greater than zero, control of the method 600 may flow as indicated by the line leading out of the right side of operation 610, to operation 618, described below.

At operation 612, the calibration manager 110 may determine if calibration or shutdown is selected. As stated previously, an operator may make a selection via the user interface 300 to skip, or start, the calibration. More specifically, clicking on the skip selection 304 indicates a request to shut down the medical system 102 without calibration. Further, clicking on the start selection 306 indicates a request to start the calibration. However, if the operator does not click on the skip selection 304 or start selection 306, control of the method 600 flows to operation 610 until the confirmation timer expires. Thus, the confirmation timer may represent a predetermined amount of time, within which the operator may make click on the skip selection 304 or start selection 306. If the operator does not make one of the selections before the confirmation timer expires, control of the method 600 may flow to operation 618, described below.

However, if at operation 612, the calibration manager 110 determines that the operator has selected shutdown or calibration, control of the method 600 may flow to operation 614.

At operation 614, the calibration manager 110 may determine if calibration or shutdown is selected. Thus, if the operator clicks on the start selection 306, the calibration is selected. However, if the operator clicks on the skip selection 304, the shutdown is selected. If the shutdown is selected, control of the method 600 may flow to operation 618, described below.

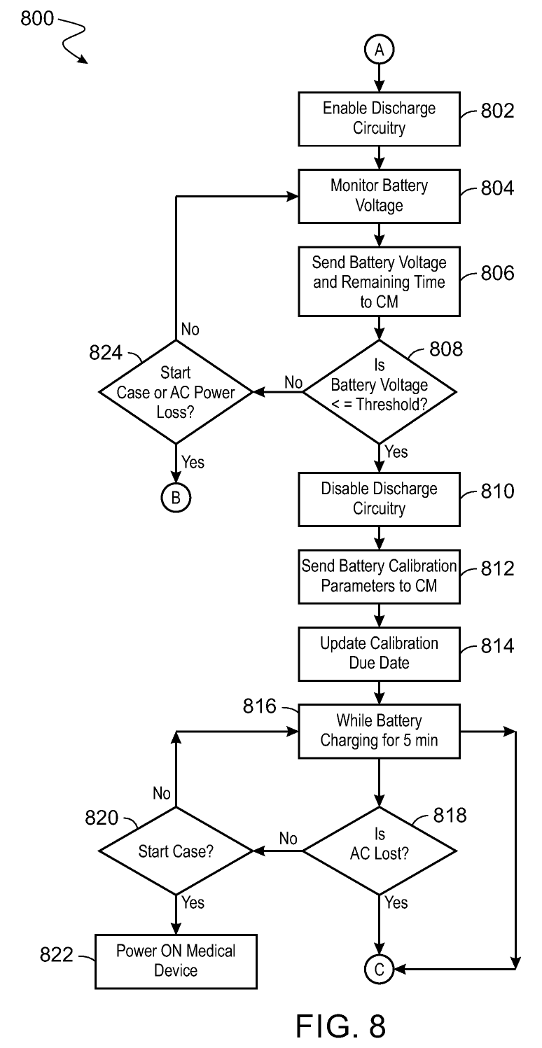

If the operator selects calibration, control of the method 600 may flow to operation 616. At operation 616, the calibration manager 110 may send a calibration request to the PMB 108. The calibration request indicates that the PMB 108 is to perform calibration of the backup battery 112. Control of the method 600 may flow from operation 616 to placeholder A. The placeholder A represents the method for calibration, described with respect to FIG. 8.

At operation 618, the calibration manager 110 may send a shutdown command to the PMB 108. Additionally, the PMB 108 may send the shutdown command to the medical system 102.

At operation 620, the medical system 102 may shut down. The medical system 102 may shut down in response to receiving the shutdown command from the PMB 108. In this scenario, the medical system 102 may shut down without calibration, either through an express selection, or expiration of the confirmation timer without selection.

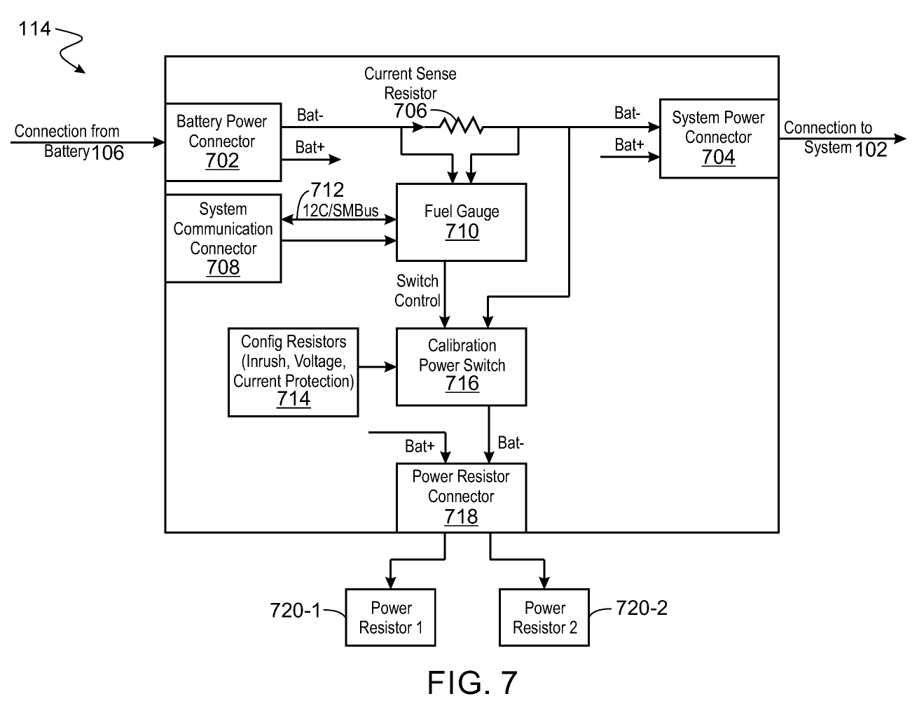

FIG. 7 is a diagram of fuel gauge board 114 according to one embodiment of the present disclosure. The fuel gauge board 114 includes a battery power connector 702, system power connector 704, current sense resistor 706, system communication connector 708, fuel gauge 710, communication bus 712, configuration (config) resistors 714, calibration power switch 716, power resistor connector 718, and power resistors 720-1, 720-2. The fuel gauge board 114 may be electrically connected with the backup battery 112 and the medical system 102. More specifically, the fuel gauge board 114 includes battery power connector 702 from the backup battery 112, and system power connector 704 to the medical system 102. Both the battery power connector 702 and system power connector 704 include positive and negative connections. Further the negative connections are connected with the current sense resistor 906. As shown, the connection from the battery power connector 702 to the current sense resistor 706, and the system power connector 704 are represented as lines with arrows pointing from left to right. The arrows indicate that power flows from the backup battery 112 to the medical system 102, when these connections are enabled by the calibration power switch 716, described below. Additionally, the current resistor 906 is electrically connected to the fuel gauge 710. The fuel gauge 710 may include a voltage sensor that measures the state of charge of the backup battery 112. Additionally, the fuel gauge 710 may provide the state of charge over the communications bus 712 to the system communication connector 708. The system communication connector 708 may be in electrical connection with a display device, or other indicator, which may display, or otherwise present the state of charge of the backup battery 112. Further, the system communication connector 708 may be in electrical contact with the medical system 102 and calibration manager 110. Accordingly, the fuel gauge 710 may exchange communications with the medical system 102 and calibration manager 110. In these communications, the fuel gauge 710 is represented with respect to the PMB 108. More specifically, the communications described with respect to the PMB 108 in FIG. 2 may be provided to, and received by the fuel gauge 710, over the communication lines 712-1, 712-2.

Additionally, the fuel gauge 710 may be electrically connected with the calibration power switch 716. The calibration power switch 716 may be configured to open an electrical path between the current sense resistor 706, and thus, the battery power connector 702. Further, the fuel gauge board 114 may include discharging circuitry, composed of the power resistor connector 718 and power resistors 720-1. The power resistor connector 718 may be configured to provide an electrical path to the power resistors 720-1, 720-2. The power resistors 720-1, 720-2 may dissipate the energy from the backup battery 112 within themselves, and provide a relatively quick and controlled discharge. According to some embodiments of the present disclosure, in response to a battery calibration request from the calibration manager 110, the fuel gauge 710 may activate the calibration power switch 716 and initiate coulomb counting for the discharging circuitry. In this example, coloumb counting refers to monitoring current to determine how much power the power resistors 720-1, 720-2 dissipate during the discharge. More specifically, the fuel gauge 710 may monitor the power discharged using the current sense resistor 706. Additionally, the calibration power switch 716 provides the path to discharge the backup battery 112 via the power resistors 720-1, 720-2. Further, the calibration power switch 716 uses the config resistors 714 to protect the battery pack 104 against under-voltage, over-voltage and high inrush current conditions

According to some embodiments of the present disclosure, the discharge circuitry may discharge the backup battery 112 to a predetermined threshold, e.g., a specific voltage, or state of charge. More specifically, the fuel gauge 710 may use coulomb counting to determine when the state of charge of the backup battery 112 reaches, or drops below, the predetermined threshold. Further, when the state of charge reaches or drops below the predetermined threshold, the fuel gauge 710 may turn off the calibration power switch 716, which stops the discharge.

Advantageously, the calibration process described above is automated with no intervention from service engineer or any human operator. Further, having two power resistors 720-1, 720-2 means that even in the event of failure of one power resistor, the calibration can continue, although with a lower discharge rate than with both power resistors. Throughout the calibration process, the fuel gauge 710 may monitor the health of the backup battery 112 to detect any potential safety issues. For example, a potential fire hazard may exist if the backup battery 112 is overheating. Further, if the fuel gauge 710 detects a safety issue, the fuel gauge 710 may signal the calibration power switch 716 to power off, thus aborting the calibration process. Additionally, the fuel gauge 710 may send a calibration abort indicator to the calibration manager 110.

FIG. 8 is a flow chart of a method 800 for a system for calibrating medical system backup batteries according to one embodiment of the present disclosure. The calibration manager 110, fuel gauge board 114, and medical system 102 may perform the method 800.

At operation 802, the calibration manager 110 may enable the discharge circuitry in the fuel gauge board 114. More specifically, the calibration manager 110 may send a battery calibration request to the fuel gauge 710 to begin calibrating the backup battery 112. In response, the fuel gauge 710 may activate the calibration power switch 716 and initiate coulomb counting for the discharging circuitry.

At operation 804, the fuel gauge board 114 may monitor the battery voltage. More specifically, the fuel gauge 710 may monitor the voltage of the backup battery 112 through coulomb counting during the discharge.

At operation 806, the fuel gauge board 114 may send the battery voltage and remaining time to the calibration manager (CM) 110. More specifically, the fuel gauge 710 may determine the current voltage of the backup battery 112 based on the voltage of the backup battery 112 before the discharge begins, and the amount of current discharged determined based on the coulomb counting. Further, the fuel gauge 710 may determine the amount of time remaining before the discharging reduces the voltage of the backup battery 112 to the predetermined threshold, e.g., lower voltage level.

At operation 808, the fuel gauge board 114 may determine if the battery voltage is less than or equal to the predetermined threshold. For example, the fuel gauge 710 may determine if the voltage of the backup battery 112 is less than or equal to the specified lower voltage. If the battery voltage is not less than or equal to the predetermined threshold, control of the method 800 may flow to operation 824.

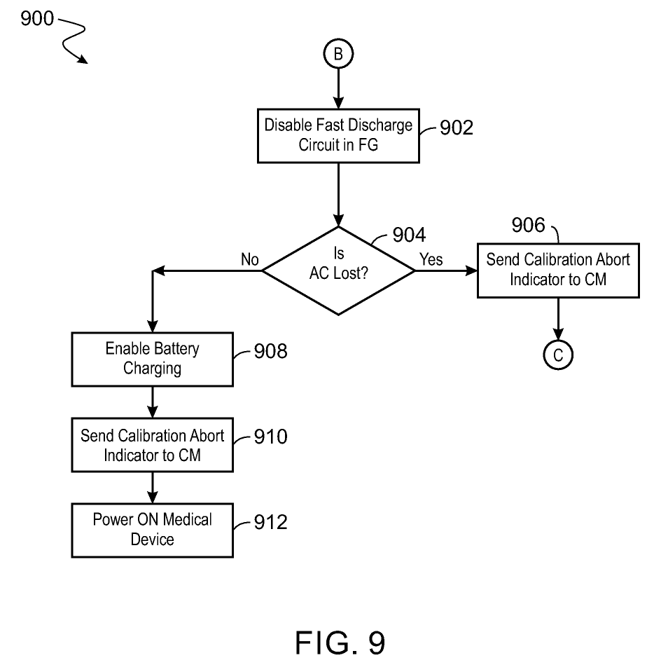

At operation 824, the calibration manager 110 may determine if a start case or an AC power loss has occurred. As stated previously, the start case occurs when an operator selects start case selection 406 from the user interface 400. If either of the start case or AC power loss has occurred, control of the method 800 may flow to placeholder B, which is described in greater detail with respect to FIG. 9. If neither of the start case or AC power loss has occurred, control of the method 800 may flow back to operation 804, where battery voltage monitoring may continue.

Referring back to operation 808, if the fuel gauge 710 determines that the battery voltage is less than or equal to the predetermined threshold, control of the method 800 may flow to operation 810.

At operation 810, the fuel gauge board 114 may disable the discharge circuitry. In other words, the fuel gauge 710 may turn off the calibration power switch 716.

At operation 812, the fuel gauge board 114 may send battery calibration parameters to the calibration manager 110. Sending the calibration parameters to the calibration manager 110 may involve the fuel gauge 710 sending the state of charge of the backup battery 112, and an indicator that the calibration is complete, to the calibration manager 110.

At operation 814, the calibration manager 110 may update the calibration due date. Once the battery discharge is complete, the next due date for calibrating the backup battery 112 may be updated. Thus, in response to receiving the calibration complete indicator from the fuel gauge 710, the calibration manager 110 may determine the next due date based on the current date, and the period of calibration. For example, if the calibration period is quarterly, the next due date may be determined by adding three months to the current date. If the calibration period is annually, the next due date may be determined by adding one year to the current date. The calibration due date may be stored in a local memory storage device.

The fuel gauge board 114 may perform operations 816 through 820 while the battery is charging for a predetermined period of time, e.g., five minutes. Once the battery discharge is complete, the PMB 108 may begin re-charging the backup battery 112. At the conclusion of the initial charging period, control of the method 800 may flow to placeholder C, where the shutdown of the medical system 102 may proceed, as described with respect to FIG. 6.

At operation 818, the fuel gauge 710 may determine if the AC power source 106 is lost. If the AC power source 106 is lost, control of the method 800 may flow to placeholder C, as described with respect to FIG. 6. Conversely, if the AC power source 106 is not lost, control of the method 800 may flow to operation 820.

At operation 820, the fuel gauge 710 may determine if the start case has occurred. If the start case has not occurred, control of the method 800 may flow to operation 816. If the start case has occurred, control of the method 800 may flow to operation 822.

At operation 822, the medical system 102 may power on. More specifically, the fuel gauge 710 may send a power on command to the medical system 102. In response, the medical system 102 may power on.

FIG. 9 is a flow chart of a method 900 for a system for calibrating medical system backup batteries according to one embodiment of the present disclosure. The fuel gauge board 114 and medical system 102 may perform the method 900. As stated previously, flow to placeholder B occurs if, during discharge of the backup battery 112, either of a start case or AC power loss occurs. A start case indicates that the operator of the medical system 102 has requested the medical system 102 be powered on. Alternatively, the AC power loss indicates that discharge of the backup battery 112 is to be stopped in order to preserve the backup battery’s power.

Accordingly, at operation 902, the fuel gauge board 114 may disable the discharge circuitry. More specifically, the fuel gauge 710 may turn off the calibration power switch 716, which may stop the discharge process.

At operation 904, the fuel gauge board 114 may determine if there is an AC power loss. If there is an AC power loss, control of the method 900 may flow to operation 906.

At operation 906, the fuel gauge board 114 may send a calibration abort indicator to the calibration manager 110. More specifically, the fuel gauge 710 may send the calibration abort indicator using the system communication connector 708. Further, control of the method 900 may flow to placeholder C, where the shutdown of the medical system 102 may proceed, as described with respect to FIG. 6. If there has not been an AC power loss, control of the method 900 may flow to operation 908.

At operation 908, the PMB 108 may enable battery charging. Enabling battery charging may involve enabling a connection between the AC power source 106 and the backup battery 112.

At operation 910, the fuel gauge board 114 may send a calibration abort indicator to the calibration manager 110. More specifically, the fuel gauge 710 may send the calibration abort indicator using the system communication connector 708.

At operation 912, the medical system 102 may power on. As determined at operation 904, there is not an AC power loss. As such, the start case has occurred. Accordingly, the fuel gauge may send a power on command to the medical system 102 using the system communication connector708. In response, the medical system 102 may power on.

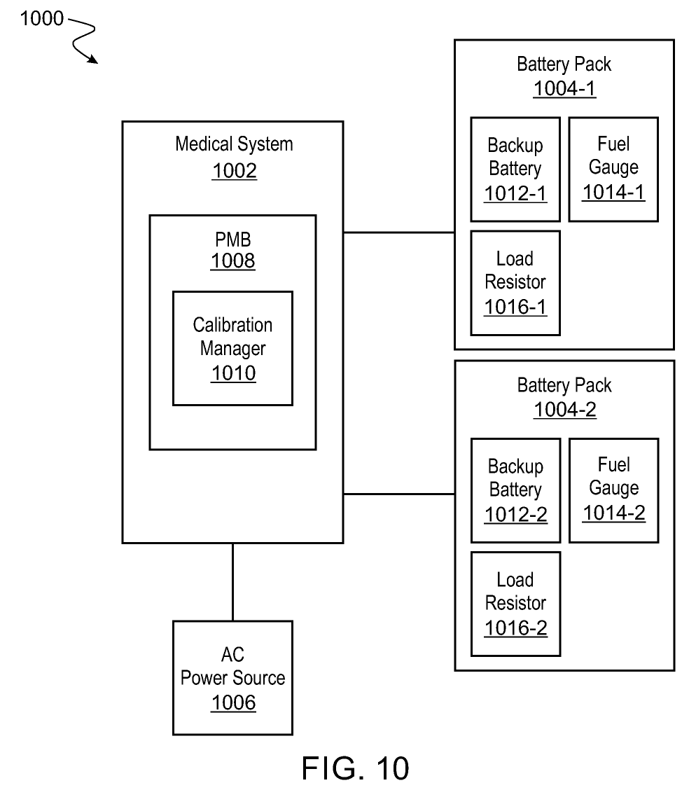

FIG. 10 is a diagram of a system 1000 for calibrating medical system backup batteries according to one embodiment of the present disclosure. The system 1000 includes medical system 1002, battery packs 1004-1, 1004-2, and AC power source 1006. Additionally, the medical system 1002 includes a PMB 1008 and a calibration manager 1010. Further, the battery packs 1004-1, 1004-2 respectively include backup batteries 1012-1, 1012-2, fuel gauges 1014-1, 1014-2, and load resistors 1016-1, 1016-2. The medical system 1002, battery packs 1004-1, 1004-2, AC power source 1006, PMB 1008, calibration manager 1010, and battery backups 1012-1, 1012-2 may be respectively similar to the medical system 102, battery pack 104, AC power source 106, PMB 108, calibration manager 110, and battery backup 112, described with respect to FIG. 1. Additionally, the fuel gauges 1014-1, 1014-2 may monitor the health, provide the battery capacity, provide battery remaining time of the backup batteries 1012-1, 1012-2, respectively. The load resistors 1016-1, 1016-2, may respectively discharge the backup batteries 1012-1, 1012-2 in order to calibrate the fuel gauges 1014-1, 1014-2.

Further, according to some embodiments of the present disclosure, the PMB 1008 may alternately connect the medical system 1002 to each of the battery packs 1004-1, 1004-2 for predetermined periods of time. For example, the PMB 1008 may connect the medical system 1002 to battery pack 1004-1 for a sixty day period, wherein if the medical system 1002 loses the AC power source 1006, the backup battery 1012-1 of battery pack 1004-1, provides the backup power source. Further, at the end of the sixty days, the PMB 108 may connect the medical system 1002 to battery pack 1004-2 for the next sixty days, wherein if the medical system 1002 loses the AC power source 1006, the backup battery 1012-2 of battery pack 1004-2, provides the backup power source. In this way, the battery packs 1004-1, 1004-2 may, on an alternating basis, provide the backup power source for the medical system 1002. While the predetermined period is sixty days in this example, according to some embodiments of the present disclosure, the predetermined period may vary, e.g., 30 days, 90 days, 180 days, and the like.

Additionally, when the PMB 1004 connects one of the battery packs 1004-1, 1004-2, the PMB 1004 may disconnect the other. More specifically, when the PMB 1004 connects the battery pack 1004-1 to the medical system 1002, the PMB 1004 disconnects the battery pack 1004-2 from the medical system 1002. Similarly, when the PMB 1004 connects the battery pack 1004-2 to the medical system 1002, the PMB 1004 disconnects the battery pack 1004-1 from the medical system 1002.

Further, when one of the battery packs 1004-1, 1004-2, is not connected to the medical system 1002, the calibration manager 1010 may automatically initiate the battery calibration for the disconnected battery pack. More specifically, the calibration manager 1010 may initiate battery calibration for battery pack 1004-1 by connecting the load resistor 1016-1 to the backup battery 1012-1, and allowing the battery to discharge. This calibration can take place in the background without user intervention. Additionally, when the backup battery 1012-1 is discharged to the predetermined threshold, the calibration manager 1010 may connect the backup battery 1012-1 to the AC power source 1006 to recharge the backup battery 1012-1 to its full capacity. Further, during this calibration, if the medical system 1002 loses power from the AC power source 1006, the PMB 1008 may use the battery pack 1004-2 as a backup power source for the medical system 1002, without disrupting the calibration of the backup battery 1012-1.

Similarly, when the PMB 1008 disconnects the battery pack 1004-2, the calibration manager 1010 may initiate battery calibration for battery pack 1004-2 by connecting the load resistor 1016-2 to the backup battery 1012-2, and allowing the battery to discharge. Additionally, when the backup battery 1012-2 is discharged to the predetermined threshold, the calibration manager 1010 may connect the backup battery 1012-2 to the AC power source 1006 to recharge the backup battery 1012-2 to its full capacity. During this calibration, if the medical system 1002 loses power from the AC power source 1006, the PMB 1008 may use the battery pack 1004-1 as a backup power source for the medical system 1002, without disrupting the calibration of the backup battery 1012-2. In this way, embodiments of the present disclosure may improve backup power access for the medical system 1002 by maintaining availability of a calibrated backup battery if the AC power supply 1006 is lost. Further, embodiments of the present disclosure can provide these improvements without user intervention, and without wait time involved for battery calibration. Additionally, there is no dependency on an operator or service user to initiate battery calibration periodically or to maintain the charge capacity of the battery in its life time. Since the backup batteries 1012-1, 1012-2 are periodically discharged on an alternative basis, the battery health is maintained in good condition throughout the life time of the backup batteries 1012-1, 1012-2. In this way, such embodiments may increase the life of the backup batteries 1012-1, 1012-2. Further, due to this periodic calibration, the fuel gauges 1014-1, 1014-2 may provide accurate battery remaining time without depending on external user or operator.

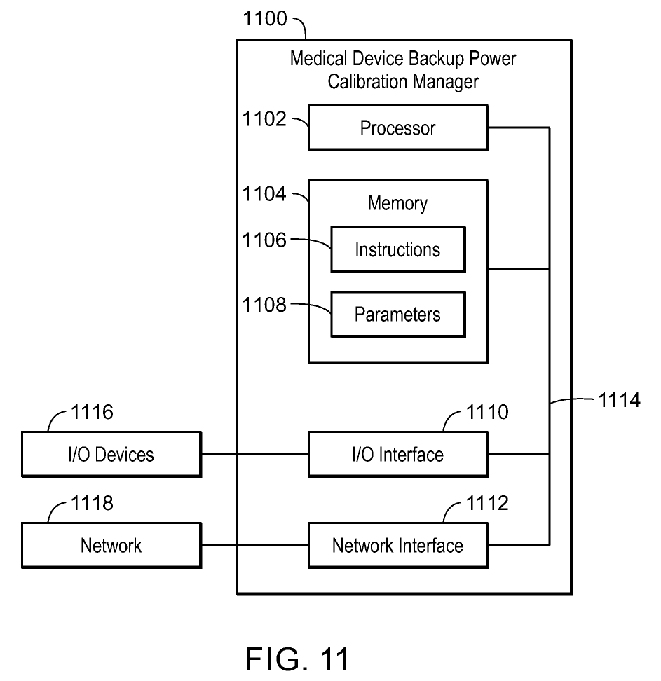

FIG. 11 is an exemplary calibrating medical system backup batteries manager 1100 according to one embodiment of the present disclosure. The example calibrating medical system backup batteries manager 1100 may be similar to the calibration manager 112, and perform calibrating medical system backup batteries as described with respect to FIGS. 1-10. In this example, the calibrating medical system backup batteries manager 1100 includes a processor 1102, memory 1104, input-output (I/O) interface 1110, and network interface 1112, which may be connected by an interconnect 1114. The processor 1102 may be a computer processing circuit (e.g., a central processing unit (CPU)) that retrieves and executes programming instructions 1106 stored in the memory 1104 to perform the functionality described herein. The interconnect 1114 may move data, such as programming instructions, between the processor 1102, memory 1104, I/O interface 1110, and network interface 1112. The interconnect 1114 may include one or more buses.

The memory 1104 may be a computer memory or storage device, including volatile memory, such as a random access memory (RAM) device (e.g., static RAM, dynamic RAM, and the like), non-volatile memory, such as a hard disk drive, solid state device (SSD), removable memory cards, optical storage, flash memory devices, and the like. In some examples, the memory 1104 may include volatile and non-volatile memory devices. Further, the memory 1104 may store instructions 1106, calibrating medical system backup batteries parameters 1108. The calibrating medical system backup batteries parameters 1108 may include calibration dates as described with respect to FIGS. 1-10.

Additionally, the calibrating medical system backup batteries manager 1100 may be in electronic communication with I/O devices 1116 through the I/O interface 1110, and with a network 1118 through the network interface 1112. The I/O devices 1116 may capture inputs and provide outputs as described herein. The network 1118 may be an electronic communication network, such as a local area network, wide area network, and the like, for processing communications between the calibrating medical system backup batteries manager 1100 and the machine learning models and AI software products described herein. In some examples, the network 1118 may be wired, wireless (e.g., wi-fi, Bluetooth, or cellular), or some other computer communication network.

In some embodiments, the calibrating medical system backup batteries manager 1100 may be a server computer or similar device without a user interface but which receives requests from other computer systems having one or more user interfaces. Further, in some embodiments, the calibrating medical system backup batteries manager 1100 may be a portable computer, laptop, tablet computer, pocket computer, telephone, smart phone, or the like.

It should be understood that the above-described steps of the processes of FIGS. 6, 8, and 9 can be executed or performed in any suitable order or sequence not limited to the order and sequence shown and described in the figures. Also, some of the above steps of the processes of FIGS. 6, 8, and 9 can be executed or performed substantially simultaneously where appropriate or in parallel to reduce latency and processing times.

It should be noted that, as used herein, the term mechanism can encompass hardware, software, firmware, or any suitable combination thereof. In some embodiments, any suitable computer readable media can be used for storing instructions for performing functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

As used herein, the term, mechanism, can encompass hardware, software, firmware, or any suitable combination thereof. In some embodiments, any suitable computer readable media can be used for storing instructions for performing functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system, for calibrating medical system backup batteries, comprising:
a processing device; and
a memory storage device comprising instructions executable by the processor to:
receive a shutdown request to shutdown a medical system having a backup battery;
determine, in response to receiving the shutdown request, that the backup battery is due for calibration based on a current date and a calibration due date; and
provide a request for a fuel gauge board of a power management board for the medical system to perform a discharge of the backup battery.

2. The system of claim 1, comprising:
the power management board for the medical system; and
the fuel gauge board, wherein the fuel gauge board comprises at least two power resistors configured to discharge power from the backup battery.

3. The system of claim 2, wherein the fuel gauge board is configured to direct the at least two power resistors to discharge the power from the backup battery, such that a state of charge of the backup battery is reduced to at least a predetermined threshold.

4. The system of claim 2, wherein the fuel gauge board is configured to direct at least one remaining functional power resistor of the at least two power resistors to discharge the power from the backup battery when a different power resistor of the at least two power resistors fails.

5. The system of claim 2, wherein the instructions are executable by the processor to direct the power management board to charge the backup battery for a predetermined period.

6. The system of claim 4, wherein the instructions are executable by the processor to direct the power management board to shut down the medical system.

7. The system of claim 4, wherein the instructions are executable by the processor to:
direct the power management board to end the predetermined period; and
direct the power management board to start the medical system.

8. The system of claim 1, wherein the instructions are executable by the processor to:
provide a shutdown confirmation interface; and
receive a shutdown confirmation from the shutdown confirmation interface, wherein determining that the calibration is due is performed in response to receiving the shutdown confirmation from the shutdown confirmation interface.

9. The system of claim 1, wherein the instructions are executable by the processor to
provide a calibration confirmation interface; and
receive a calibration confirmation selection, wherein the request for the fuel gauge board of the power management board for the medical system to perform the discharge of the backup battery is provided in response to receiving a selection of the calibration confirmation.

10. The system of claim 1, wherein the instructions are executable by the processor to:
provide a charging interface;
receive a start case selection from the charging interface; and
direct the power management board to start the medical system in response to receiving the start case selection.

11. The system of claim 1, wherein the instructions are executable by the processing device to:
receive an indication that the discharge is complete; and
update the calibration due date based on the current date and a predetermined battery calibration period.

12. A method for calibrating medical system backup batteries, comprising:
receiving a shutdown request to shut down a medical system having a backup battery;
determining, in response to receiving the shutdown request, that the backup battery is due for calibration based on a current date and a calibration due date; and
providing a request for a fuel gauge board of a power management board for the medical system to perform a discharge of the backup battery.

13. The method of claim 12, comprising directing a fuel gauge board of a power management board for the medical system to discharge power from the backup battery, such that a state of charge of the backup battery is reduced to at least a predetermined threshold.

14. The method of claim 13, comprising directing a first power resistor of at least two power resistors of the fuel gauge board to discharge the power from the backup battery when a second power resistor of the at least two power resistors fails.

15. The method of claim 13, comprising directing the power management board to charge the backup battery for a predetermined period.

16. The method of claim 15, comprising directing the power management board to shut down the medical system.

17. The method of claim 15, comprising:
directing the power management board to end the predetermined period; and
directing the power management board to start the medical system.

18. The method of claim 12, comprising:
providing a shutdown confirmation interface; and
receiving a shutdown confirmation from the shutdown confirmation interface, wherein determining that the calibration is due is performed in response to receiving the shutdown confirmation from the shutdown confirmation interface.

19. The method of claim 12, comprising:
providing a calibration confirmation interface; and
receiving a calibration confirmation selection, wherein the request for the fuel gauge board of the power management board for the medical system to perform the discharge of the backup battery is provided in response to receiving a selection of the calibration confirmation.

20. The method of claim 12, comprising:
receiving an indication that the discharge is complete from the power management board; and
updating the calibration due date based on the current date and a predetermined battery calibration period.
